(19) United States
(12) Patent Application Publication
(10) Pub. No.: US 2010/0017118 A1
(43) Pub. Date: Jan. 21, 2010

(54) PARKING & LOCATION MANAGEMENT PROCESSES & ALERTS

(75) Inventor: Casey Maureen Dougherty, San Francisco, CA (US)

Correspondence Address: Apple Inc.;c/o Novak Druce + Quigg LLP, 1000 Louisiana Street, Fifty-Third Floor, Houston, TX, 77002, US

(73) Assignee: Apple Inc., Cupertino, CA (US)

(21) Appl. No.: 12/174,567

(22) Filed: Jul. 16, 2008

(51) Int. Cl. G01C 21/34; G01S 5/00

(52) U.S. Cl. 701/209; 701/213

(57) ABSTRACT

Aspects include using present location information for a mobile device and real-time access to sources of data about future constraints pertaining to the present location to establish the occurrence of a future event. Examples include using a present location of the mobile device to infer a vehicle location, accessing a source of data relating to parking regulations at the present location and setting a reminder for avoiding violation thereof. The mobile device can track a present position and adjust an absolute reminder time to account for travel times. The travel times can be arrived at by obtaining data concerning public transportation schedules and present locations of elements of such public transportation. Another example aspect includes correlating a user profile concerning parking requirements with a desired destination area and parking regulations pertinent to the area for guiding a user to potential parking locations.

### FIELD

The following relates generally to provisioning mobile devices with information and services pertaining to a location.

### RELATED SUBJECTED MATTER

It has been considered to provide advertisements and other information pertaining to a present location of a mobile device. For example, detecting a present location of a mobile device, and providing information, including advertisements, about restaurants in that vicinity is an application that has generated interest.

Web sites also are known to allow provision of location-specific information. For example, a web site can work by a user providing a locale, and a type of information in which the user is interested; the web site searches a database using those inputs and provides outputs accordingly.

Further innovations in these areas remain desirable.

### SUMMARY

Aspects include a method relating to implementing location aware services for mobile device users. The method comprises determining a first location based on a location of a first device by machine processing of one or more of GPS signals and triangulation information. The method also comprises retrieving parking regulations, through the first device, from a source of such information pertinent to the first location, algorithmically determining, based on a current time and based on the parking regulations, a timing of an alert to avoid violating the parking regulations pertinent to the first location. The method also comprises automatically programming the alert into the first mobile device.

The alert timing can be determined based on a number of factors including tracking a current location of the first device, estimated travel times based on current public transit schedule information, current locations of public transit vehicles on one or more routes leading from a current location to the first location, a current mode of user transport, and so on.

Another aspect includes a method useful in location-aware mobile devices, comprising determining a first device location by machine processing of one or more of GPS signals and triangulation information, and receiving, over a wireless network, at the first device location an indication of a second device location. The method also comprises determining a destination, based on the first device location, the second device location, a database of points of interest, information concerning shared interests between respective users of the first device ad the second device, and transit options from at least the first device location to the destination. The method further comprises determining directions for navigating from the first device location to the destination, where the directions including a multi-leg route involving driving an automobile to a parking location, and then using a form of transportation other than the automobile to reach the destination. The directions also can be based on current public transit information including current locations of public transit vehicles on one or more routes leading from the first device location to the destination.

Still other aspects include a method of location-aware alerts on mobile devices, comprising determining a return-to location as a current location of a first device by machine processing of one or more of GPS signals in the first device and triangulation information. The method also comprises determining a return-by time based on parking regulations retrieved by the first device through a data network from a source of such information pertinent to the return-to location. The method further comprises iteratively performing steps comprising re-determining the current location of the first device, determining an estimated travel time to reach the return-to location from the current location, and adjusting a return-now time based on the return-by time and the estimate travel time. The method further comprises activating the return now alert when a current time is about equal to the return-now time.

Still other aspects include a mobile device for device location based services, comprising: a wireless interface operable to send and receive information over a wireless network, and a GPS receiver operable to receive global positioning satellite signals and derive a position for the mobile device from the signals. The device also comprises a processor configured to receive the position as an alert position, request delivery of information over the wireless network comprising parking regulations pertinent to the first position, use the parking regulations and other contextual information to formulate an alert definition for avoiding violation of the parking regulations, and update a time for the alert based on then-current positions of the mobile device,. Each updated time for the alert can be based on estimating a time needed to return to the alert position from each then-current position of the mobile device.

Still further aspects include a method of using current mobile device location and surroundings information, comprising receiving an indication of an intended destination of a user, to be reached by means other than an automobile in which the user is presently occupying, and determining a present location of the mobile device by machine processing of one or more of GPS signals and triangulation information.

The method also comprises retrieving parking regulations pertaining to a plurality of distinct parking opportunities, over a data network, from one or more sources of parking information, and forming a first travel time estimate from each of the parking opportunities to the intended destination, and a second travel time estimate from intended destination to each of the parking opportunities. The method further comprises forming a total time required estimate that includes the first travel time estimate, the second travel time estimate and a time at the intended destination. The method also comprises providing an indication of which of the parking opportunities allow parking for at least that total amount of time, receiving a selection of one of the parking opportunities from the user; and providing directions from the present location of the mobile device to the selected parking opportunity.

### BRIEF DESCRIPTION OF THE DRAWINGS

The following drawings show examples and are used to explain aspects of how devices may be used by users to obtain more integrated location-specific transportation and vicinity information.

FIG. 1 shows an example of a system comprising location-aware mobile devices that may communicate with various information services that access databases having a variety of information from a variety of sources;

FIG. 2 shows an example block-level architecture of one of the mobile devices;

FIG. 3 shows a map of an area in which information obtained from databases shown in FIG. 1 can be used for a variety of purposed described herein;

FIG. 4 shows a layout of an example geographic boundary for a parking restriction zone;

FIG. 5 shows steps of a first method including several aspects described herein;

FIG. 6 shows a subset method that can be used in the method of FIG. 5;

FIG. 7 shows another method and data relationships relating to the description for organizing and using information available from the databases of FIG. 1; and

FIG. 8 shows an example of a user interface for providing the information described with respect to the above methods and systems.

### DETAILED DESCRIPTION

Providing information to a mobile device based on its location, as well as based on user-specified category information provides a basic level of location-specific services to a user. However, the following description, in conjunction with the figures briefly described above, discloses aspects of further levels and kinds of services that may prove useful to mobile device users. One concern is that conceptions of locationally aware services generally call for provision of information to a device based on device location, but a user still is responsible for interpreting such information and for combining the usage of such information with other information that may be helpful. Therefore,

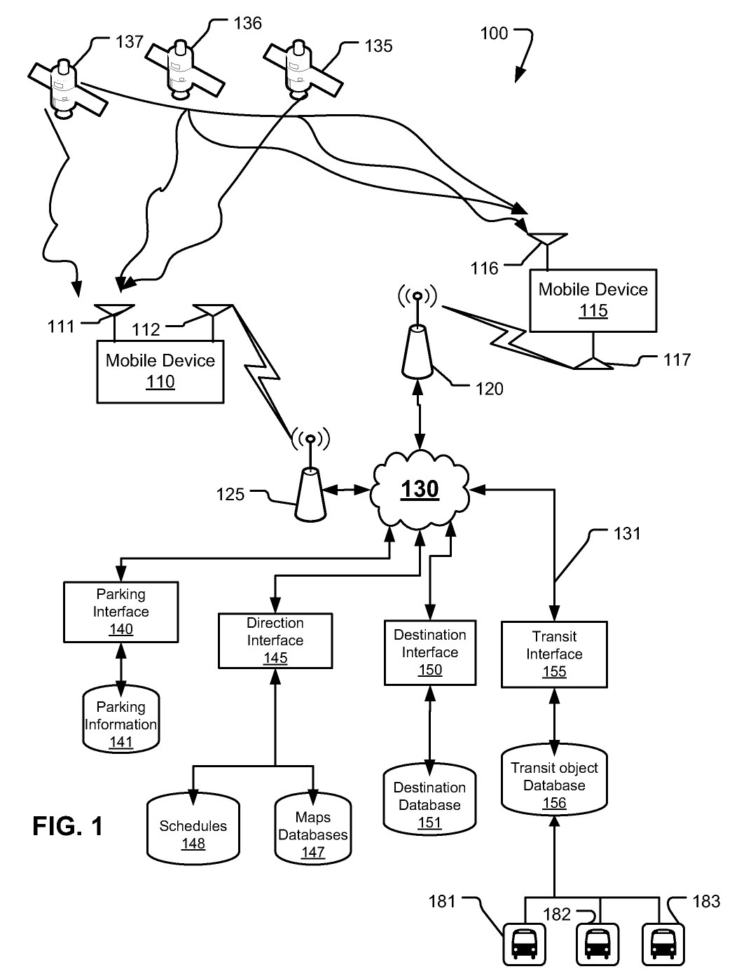

FIG. 1 illustrates a first example system architecture 100 for providing enhanced location-based services according to the examples and aspects presented. Architecture 100 includes Global Positioning System (GPS) satellites 135, 136 and 137. As is known in the art, these satellites provide downlink signals receivable by a device, and based on the received downlink signals, the device can triangulate a position in two or three dimensions. Here, the term “Global Positioning System” is used because of its familiarity to those of ordinary skill in the art, but should be considered to encompass any system that can provide locational information for a receiver of signals from a plurality of points, and from which the locational information can be derived.

Architecture 100 also includes a first mobile device 110 having a first GPS antenna 111 and a second antenna 112 for sending and receiving data over a network from a first access point (base station) 125. The network can be formed with any wireless network technology, such as a Local Area Network technologies including types specified in 802.11, and/or broadband wireless technologies, such as different types of 3G wireless and 4G wireless technologies. A second mobile device 115 has a first GPS antenna 116 and a second antenna 117 for data networking. Second mobile device 115 communicates through its second antenna 117 to a second access point (base station) 120. Both base station 120 and base station 125 are connected into a wide area network, such as the Internet or portions thereof (illustrated as network 130).

Architecture 100 also includes a parking information database 141 accessible through a Parking interface 140, a map and route database 147 that can interface to the network 130 through a Directional interface 145, a destination database 151, accessible through a Destination interface 150, and a transit object database 156, accessible through its Transit interface 155. Each of these databases, its corresponding interface, and any application using the database can provide access to the mobile devices 110 and 115 for retrieving information stored therein. Examples of information available from such databases is described with respect to particular usage models and methods in which such data can be used.

Public transit vehicles, exemplified by icons 181-183 can feed their present positions via network (e.g., wireless) transmissions through intermediate base stations and other intermediate network nodes to the transit object database 156. Such public transit vehicles can include, for example, busses, light rails, and trolleys, cable cars, or any other type of conveyance available for public use. For example, even a taxi company could decide to transmit present positions for its cabs that have no current occupant, and refrain from providing locations for its cabs that currently have fares. Therefore, the database 156 would be expected to have locational information for conveyances that may be able to transport a person.

Each database can be made accessible through its interface, and such interface can be implemented as a web services interface, such that software provided according to the following examples can more easily access information in a predictable format without intervention from a user. For example, access can be provided using an XML interface that allows communication between the devices using metadata formats that largely avoid an interface designed for human access. For example, in the context of Directional interface 145, it may publish a web service that accepts XML formatted information including an origin specified in any of a plurality of formats, and a destination in any of the formats. For example, a lat/lon coordinate pair may be used to input the origin and destination. Different tags may be used to indicate different formatting of output information, as will be explained further below.

Also, different output can be obtained from Directional interface 145 based on the data requested. For example, a map can be obtained based on indicating a map request and a location. Directions may be obtained based on provision of two or more points, between which directions are requested. Such different outputs can be requested

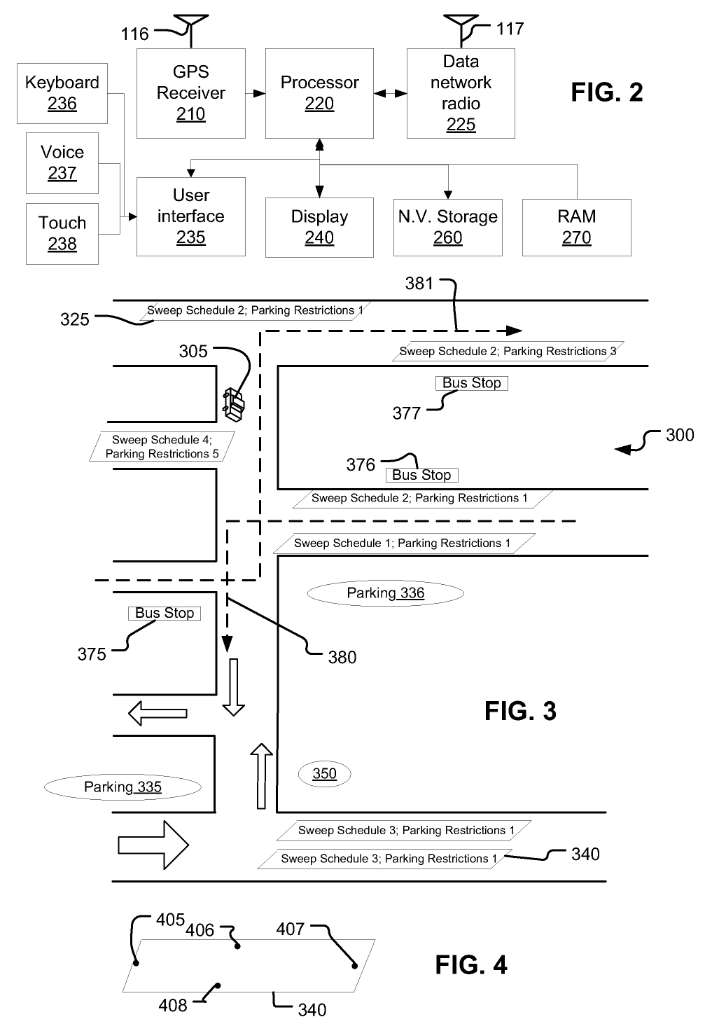

FIG. 2 illustrates an example implementation of one of the mobile devices 115. Device 115 includes antennae 116 and 117, which were described with respect to FIG. 1 as being available for receiving GPS transmissions and for sending and receiving data using a data network. FIG. 2 illustrates that a radio 225 drives antenna 117 and also processes signals received from antenna 117. An applications processor 220 sends data to and receives data from the radio (the radio can receive baseband data in some implementations, or can be implemented as a single chip with a bus interface). Radio 225 also represents various other discrete components and the like that may be used in implementing that functionality. A processor 220 interfaces with the radio 225. The processor 220 can be implemented as one or more cores in a monolithic chip with portions of the radio 225, or can be a separate chip, as specific to an implementation.

Processor 220 receives GPS location data from GPS receiver 210. GPS receiver preferably processes the raw GPS signals to produce a latitude/longitude (lat/lon) coordinate pair for usage by processor 220. The GPS receiver 210 can also produce an elevation estimate, as well as provide a current time, and can also represent position information in other ways.

Processor 220 interfaces with Non-Volatile storage 260, with RAM 270, and with a user input interface 235 that provides an interface to different kinds of user input devices, including a keyboard 236, voice input 237, and a touch screen interface 238. Processor 220 also outputs information for display on a display 240, over which touch screen interface 238 can be provided. In some implementations, a separate graphics processor can be provided, or interface functionality can be provided with processor 220. The example implementation can vary based on the type of device; for example, a mobile device having more sophisticated graphics and ability to provide rich media and game playing experiences may have a separate application processor, while ones that are more cost-sensitive may provide one or more cores on a chip that also provides the data network interface. Of course, as hardware and software continue to evolve, implementations of these examples also will evolve.

A first example application provides a user of a mobile device with synthesized parking instructions based on disparate sources of information for such parking. A motivational example is that San Francisco, Calif. has over 60 street sweeping route schedules, during which automobiles may not obstruct the sweeper's path. The schedules normally restrict parking only for a relatively small window of time, once or twice a week. The schedules can vary on different sides of the same street. Meter time restrictions provide another level of complexity to parking. It can be difficult to find parking in some San Francisco neighborhoods at all, and in view of these additional complications, many people continue to unwittingly accrue parking violations. Also, other parking opportunities such as garages can only be accessed from certain streets, and each may offer differing price plans, sometimes depending on their target market (e.g., professional travelers, commuters, or recreational visitors).

In that vein, FIG. 3 illustrates a small portion of a map 300 for a metropolitan area that includes a variety of distinct street sweeping and parking restriction rulesets shown along the portions of the metropolitan area in which they respectively apply. For example, (sweep schedule 2, parking restrictions 1) is identified as 325. The numbering of the schedules and restrictions is provided for the sake of convenience and can be considered to reference a table or a database of such schedules (illustrated infra). For example, many parking restrictions are similar or the same, and so, each would not need to be separately identified, but can simply be referenced in a database lookup. Of course, in a machine representation, such identifiers can be any identifying string referenced to a particular geographical location.

For example, each of the separately identified parking restriction zones (e.g., zone 325) can include information defining a start of the zone, and an end of the zone. Such information can include at least a starting latitude or longitude coordinate and an ending latitude or longitude coordinate. Although in some cases it may be unnecessary to specify both a latitude and a longitude for each of the start and the end, these cases would likely be limited and the loss of generality would be likely not worth the savings in storage space.

Other items illustrated in FIG. 3 include a vehicle 305, which illustrates a present location of a driver of that vehicle, as is relevant for some aspects disclosed herein. Other aspects include parking garages 335 and 336, bus stops 375, 376, and 377. Still other aspects include bus routes 380, and 381. These aspects are used in examples for aspects herein.

FIG. 4 illustrates location information 400 that may be included in a parking restriction zone (e.g., 340 of FIG. 3). Locational information 400 generally would include a beginning 405 and an end 407 of the zone. In cases where the zone was along a street, these may be the only data used to define the geographic extent of the zone, and an overlay of street information would be used to define a width of the zone, where necessary. Other zones can be associated with locational information including a left 406 and right 408 extent (arbitrarily assigned as left/right). In cases where a parking zone may be a lot with parking meters, for example, then there may be four data points defining an extent of the zone. Of course, in other implementations, each zone may include four points marking the corners of the zone. Still other implementations are possible, and FIG. 4 illustrates an example where at the minimum a start and end can be defined, and optionally a width. The width definition also can be used if different sizes of the street have differing restrictions. Such locational information also can be lat/lon coordinate pairs, or a coordinate pair, with two lengths specified. Other geometric shapes also can be defined with more than four corners, but for simplicity, a generally rectangular zone is considered the normal.

Table 1 illustrates an example of sweep schedule information that may be represented in a database. Since the database is preferably formatted in a metadata format for ease of interpretation by software or other applications, the data would not necessarily be presented in the format shown, but would be encoded in a manner selected based on the implementation. For example, tags may be used to identify the schedule ID fields, the date fields, and the time fields. These schedules would be geo-referenced to the zone definition data described with respect to FIG. 4, by, for example, inclusion of a zone ID as shown in column 2 of Table 1. Of course, the zone definition data of FIG. 4 also could be explicitly provided in Table 1. However, then an update to the definition of each zone would need to be reflected in each place where that data appears. Thus, it is preferred to reference the zone data in Table 1 and other tables described below.

Date and time data in Table 1 can be represented as calendar days, or days of the week, or an alternative implementation, such as a numbering convention that conveys the same meaning. For example, it would be easier, in the case of a sweep occurring each Tuesday to just indicate that the sweep happens on Tuesday, which could be indicated by a binary bit pattern of 3 bits, where 011 represents Tuesday. Of course, data protection features, such as CRC, or parity bits and the like also could be used in such numerical implementations. In any case, table 1 can be located with parking information database 141 (FIG. 1) and can be accessible through Parking interface 140 by a web service allowing specification of a location.

TABLE 1
Sweep Schedules

| Schedule ID | Zone ID | Dates | Times |
|---|---|---|---|
| Schedule 1 | . . . | Tu. | 04:00-06:00 |
| Schedule 2 | 325 | Th. | 06:00-08:00 |
| Schedule 3 | 340 | Fr. | 02:00-03:00 |
| Schedule 4 | . . . | Alt. Mo. | 02:00-03:00 |

The other component of parking information database 141 in this example includes parking schedule information, represented by Table 2, below. Parking schedule information can include a schedule identifier, and a parking zone cross reference/identifier. Here also, the content of the data can include date information, time information, and restriction information. The date and time information can be provided in different formats, as dictated by the metadata associated with information, which helps interpretation of such data. For example, there can be a tag specifying a particular date, as well as a tag for recurring dates (e.g., first Tuesday of the month), or simply a day of the week representation. Similarly, any number of different time formats can be envisioned, but a convenient one is a 24 hour time representation a beginning and an end for a given entry. Also, the restriction can be represented as a maximum parking duration allowed, where a zero duration means no parking. Similarly, time can be presented in a given increment, which can be fixed among entries or can be variable. For example, a half hour increment can be provided, or a 15 minute increment, such that for example, a number 4 could be interpreted as 4 half hour segments (i.e., 2 hours). In some implementations, the increment can be specified with the entry, which can then be used to convey information as to what the time increment of a meter in that zone is (e.g., 10 minute increments for a quarter).

TABLE 2
Parking Schedules

| Schedule ID | Zone ID | Dates | Times | Restriction | |
|---|---|---|---|---|---|
| Restrictions 1 | 325; 340 | Mo.-Fr. | 08:00-18:00 | 2 | hours |
| | | Sat. | 10:00-14:00 | No Parking | |
| Restrictions 2 | . . . | Mo.-Fr. | 06:00-08:00 | .25 | hours |
| Restrictions 3 | . . . | Mon.-Fri. | 07:00-17:00 | 1 | hour |

. . .

| | | | | | |
|---|---|---|---|---|---|
| Restrictions n | . . . | Sat.-Sun. | 15:00-24:00 | 3 | hours |

In the particular example of FIG. 3 and Table 2, both the identified zones 325 and 340 were associated with Restrictions 1, which indicates two separate entries of 2 hour parking limit between the hours of 8:00 AM and 6:00 PM on Monday-Friday, and no parking between 10:00 AM and 2:00 PM on Saturdays.

The logic of the Parking interface 140 can be programmed to identify the most restrictive rule applicable in a given situation, and return that rule. For example, if Restrictions 1 had a further entry that specified no parking on the Monday of Memorial Day, then that more specific restriction would control the outcome of the database lookup, being more specific than the general 2 hour parking allowance on weekdays.

Alternatively, the database can return all entries associated with a particular zone, and allow the requesting device to determine what the most restrictive rule applicable in a given circumstance is.

Table 3 illustrates an example of information that may be stored in the schedules 148 database of FIG. 1, and which includes Transit Route Schedules. Table 3 includes schedule identifiers, dates as to when the schedule is in effect, times of the schedule, and a frequency of repetition. The frequency represents a nominal time during which another vehicle should pass by each station for that route. In many situations, a given route will have different schedules on a work day versus on a holiday or a weekend, and so it is contemplated that each route may have multiple entries, as shown with respect to Route 1. Such a transit schedule represents the planned schedule, which may deviate from actual transit schedules, as described further below. The Schedule ID can also explicitly identify, or otherwise include another layer of hierarchy to specify the mode of transportation. For example, the schedule ID can indicate that the route is a bus route, versus a train, or trolley route. Alternatively, separate tables can be provided for each transportation type. Since it is expected that the table/database ultimately is to be referenced using machines, the general notion of separating such schedule information, as would be expected for human consumption is less relevant.

TABLE 3
Transit Route Schedules

| Schedule ID | Dates | Times | Frequency |
|---|---|---|---|
| Route 1 | Mon.-Fri. | 08:00-18:00 | 0.3 hours |
| | Mon.-Fri. | 18:00-24:00 | 0.5 hours |
| | Sat. | 09:00-14:00 | 0.5 hours |
| Route 2 | Mon.-Sat. | 09:00-18:00 | .25 hours |
| Route 3 | Mon.-Fri. | 07:00-17:00 | 1 hour |

. . .

| | | | |
|---|---|---|---|
| Route n | . . . | . . . | . . . |

The schedule information stored in 148, and as represented in Table 3 can be used in conjunction with the map and route information of database 147. For example, database 147 may include location information for each route specified in Table 3, as well as maps of the areas intended to be served by database 147. Transit schedule information also can be stored to be accessible through Transit interface 155, and direction interface 145 can be programmed to retrieve scheduling information from Transit interface 155.

In any case, Directional interface 145 can be used to request directional information, and return a map or other information showing routes of transit vehicles that go through streets proximate that location. Such a location can be a location of a desired destination or of a present location of a wireless device of FIG. 1. As such, Directional interface 145 provides a service that can return transit vehicle schedule information in response to receipt of position information. Directional interface 145 also can receive multiple positions, and can interpret those positions, for example, as an origin and a destination for which a route is to be planned. Further, Directional interface 145 can receive three or more points, and can interpret a first point in such an ordered list as an origin, then each subsequent point as being a point for which directions from the previous point are requested.

In this context, other information can be provided in such directional requests. For example, it can be specified that a transit route is needed from the first point to the second point, while in the absence of a specific type of transit request, the Directional interface 145 can assume that an automobile is being used.

For example Table 4 illustrates types of requests that can be formulated by mobile device 110 (e.g.) to be made of directional interface 145. For a first request (Request 1), Table 4 illustrates that request 1 can comprise a first lat/lon pair (L1/L1) specifying an origin from which directions are requested to a first destination (D1), specified by a second lat/lon pair (L2/L2), at a time T1 and a specified mode of transportation (automobile). A default where no time is specified here is as soon as possible, and a default for transportation can be automobile, or can be user-defined. Then, the sequence continues for each additional location, i.e., that D1 is an origin for directions to D2 where now the transportation is specified as being anything other than automobile (e.g., transit or walking, or in some cases, can also include taxi). The time, T2 unless specified otherwise would be calculated based on an estimated time of arrival based on the time T1 and an estimated time of travel. Similarly, from D2 to D3 the mode of transportation is specified as being walking, while from D3 to D4, the transmit mode is required to be transit. So, it can be seen that transportation modes can be specified restrictively or broadly, e.g., must be automobile, must be transit, must not be automobile, and so on.

This allows a more real-world usage model of directional interfaces for urban applications, where often parking is not immediately available at an ultimate destination, or where a requester may desire to walk one direction (e.g. during the daylight), but may not want to walk back (e.g., during the night). Also, in urban applications, directions suitable for a car can differ dramatically from walking directions. For example, a car cannot climb stairs, but a person may be able to, and directions through such an area specialized for walking can avoid circumlocution.

TABLE 4

| Req. | O | T1 | Trans. | D1 | Trans. | T2 | D2 | Trans. | T3 | D3 | Trans. | T4 |
|---|---|---|---|---|---|---|---|---|---|---|---|---|
| 1 | L1/L1 | T1 | Auto | L2/L2 | Non- | T2 | L3/L3 | Walk | T3 | L4/L4 | Transit | T4 |
| | | | | | auto | | | | | | | |

Likewise, for planning purposes a transit schedule can be useful, but more pragmatically, more current information is often required to allow comfortable transitions between different modes of transportation. For example, if a person has to wait 15 minutes for a late bus for a 45 minute trip, then waiting consumed ⅓ of the entire trip time. Also, such transit vehicles increasingly have GPS position equipment to sense their positions, which can be sent to a database for tracking, provided that the transit vehicles also have network transmission capabilities, such as a provisioned wireless network, which can include a wireless local area network, or another suitable technology.

An example of a database representing an aggregation of GPS position information is shown in Table 5, below. Table 5 includes an object identifier for each transit object reporting a position, and an identifier for the route that it currently is on. The entry can include a reported position, a reported time, an estimate time to the next stop and identifying information for the next stop. In addition to the reported position, the other information can allow for interpolating an updated position for the vehicle when the data is stale. As with the other examples, the data can be formatted and tagged with metadata to ease machine interpretation of the data. Not all the data presented in the example of table 5 need be included. For example, the next stop location can be inferred from a reported position, in view of information about the route the vehicle is on. Likewise, if the refresh rate of the data is sufficiently rapid, then the report time entry may not need to be maintained because the data is not stale enough to gain much advantage by knowing that the data is 15 seconds old versus 45 seconds old. Usages of this data are discussed further below.

TABLE 5
Transit Object Locations

| | | | | Time to | |
|---|---|---|---|---|---|
| Object | Route | | Report | next | Next Stop |
| ID | ID | Position | time | stop | Location |
| Bus 1 | 1.1 | Lat. 11/Lon. 11. | 08:15 | 08:19 | Lat 12./Lon 12. |
| Bus 2 | 1.1 | Lat. 13/Lon. 13 | 08:18 | 08:22 | Lat. 14/Lon. 14 |
| Bus 2 | 1.2 | Lat. 21/Lon. 21 | 08:12 | 08:18 | Lat. 22/Lon. 22 |

. . .

| | | | | | |
|---|---|---|---|---|---|
| Train 1 | 2.1 | Lat. 31/Lon. 31 | 08:12 | 08:30 | Lat. 32/Lon. 32 |

Another variable that can factor into decisions concerning transit and parking choices is relative costs. In particular, parking in garages versus parking on streets can differ markedly in costs. Also, garages can have different rate structures that may mean one garage is more appropriate for a given situation than another. Thus, Table 6 illustrates an example of street parking data that can be stored in a database or other mechanism designed to provide access to such data. The data can include a Schedule identifier to identify a particular schedule, which allows referencing the schedule for particular parking zones. For example, a parking restriction zone can be cross-referenced to a parking schedule. Each schedule then can include one or more date/time and cost entries. Here also a more restrictive date/time entry for a given schedule controls a more general entry. For example, Schedule 1 has an entry applicable Mon.-Fri. and also a more specific entry where particular dates are free parking days. Thus, for example, if 1/1 (i.e., January 1) where a Monday, then parking would be free, and the more specific entry would control. Here also, logic implemented by the provider of the web service may implement this decision making, or multiple related entries may be returned, allowing a client to determine a controlling entry.

TABLE 6
Street Parking Costs

| Schedule ID | Dates | Times | Cost |
|---|---|---|---|
| Schedule 1 | Mon.-Fri. | 06:00-18:00 | $4.00/hr |
| | Sun. | 00:00-24:00 | Free |
| | 1/1; 5/30; | 00:00-24:00 | Free |
| | 07/04 . . . | | |
| Schedule 2 | Mon.-Fri. | 06:00-18:00 | $8.00/hr |

. . .

| | | | |
|---|---|---|---|
| Schedule n | Mon.-Fri. | 09:00-17:00 | $3.00/hr |

Table 7 shows an example of data that can be contained in a database for garage parking costs. Table 7 includes entries that have an identifier for each garage, and a location for the garage. There can be an entry for each of a per hour charge, a maximum charge and a closing time. In some cases, the ID can be a text string that would be recognizable to a human, such as cross streets for the garage, or in other cases, it may be simply be an identifier string. Since one garage would not physically exist within another, a lat/lon coordinate for the garage also could serve as its identifier (i.e., a separate identifier is not mandatory). Here also, usages for such information are illustrated below.

TABLE 7
Garage Parking Costs

| Garage ID | Location | Per Hour | Max | Closing |
|---|---|---|---|---|
| Garage 1 | Lat/Lon 1 | 8.00 | 20.00 | 23:00 |
| Garage 2 | Lat/Lon 2 | 12.00 | 30.00 | 02:00 |

. . .

| | | | | |
|---|---|---|---|---|
| Garage n | Lat/Lon 3 | 4.00 | 15.00 | 03:00 |

Thus, examples of information that can be made available through web services includes the examples included from Tables 1-7. Although these examples were presented as a number of databases providing information through interfaces to a requesting user device, one database also could aggregate this information in other examples, and allow access through one interface. Applications and usage models for such data provided on mobile devices are now addressed.

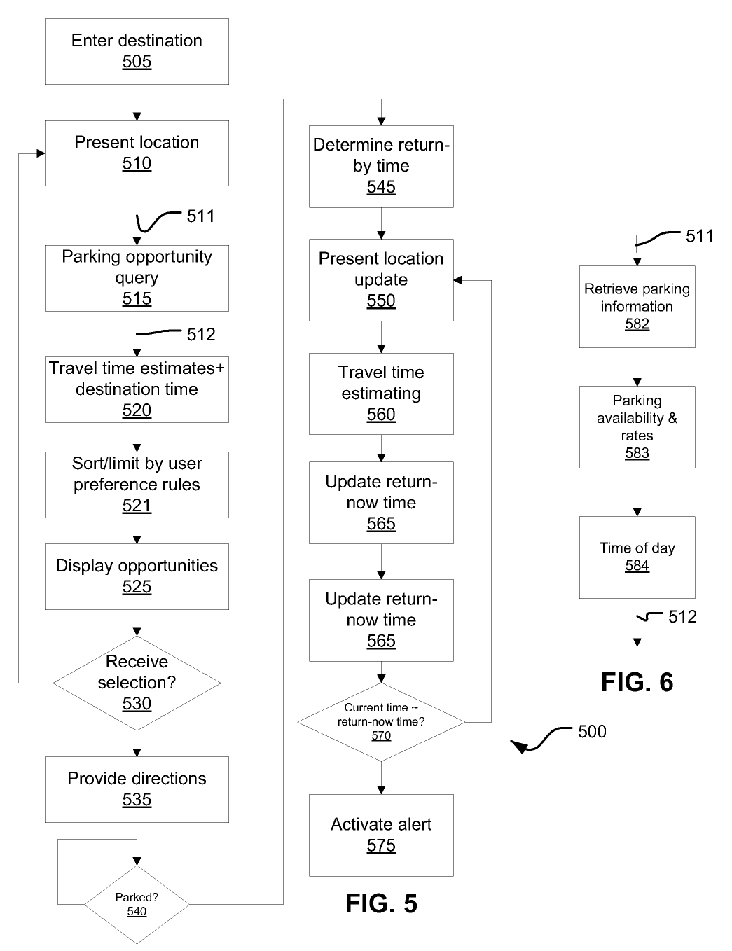

FIG. 5 illustrates an example method 500 using the information described above, and involves example system 100. In method 500, a user, or a user's agent, can enter (505) a destination in device 115, which also tracks or otherwise determines (510) a present location of the device. Device 115 then enters a parking query mode in a transition between 510 and 515 (identified as 511). The parking query mode includes retrieving (582) parking-related information for the present location comprising a sweep schedule (Table 1) and street parking restriction information (Table 2). In the example system 100 of FIG. 1, this information is available by providing the current position to a web services interface provided by Parking interface 140, which interfaces with the storage location for such information (141).

Method 500 can also include retrieving (583) other parking information, including information for parking in a garage around the destination. Factoring in the time of day (584) and using direction information fetched through Directional interface 145 relating to routes for reaching the entered destination from any of the parking opportunities (garage and street) identified in 582 and 583, the device 115 can provide travel time estimates for reaching the destination from the different parking opportunities (or Directional interface 145 may provide such travel time estimates) In this example, the travel time estimates determination can include transportation specific restrictions or information. For example, device 115 may specify to the directional interface that one or more different kinds of transportation are required or are excluded from a route calculation. As shown in Table 4, above, a query from device 115 can specify a type of transportation desired or excluded. Based on the position information provided, interface 145 can query its schedule database 148 and provide proposed route(s) to the device 115. The device can in turn use the route information from interface 145 to query Transit interface 155 for current positional information for the next transit object (step 555) on each route proposed by the interface 145.

Based on the route information provided, Transit interface 155 queries its database 156 and can provide responsive locational information for transit objects to device 115.

Thus, at this point, device 115 can have estimated travel times based on both scheduled transit service as well as quasi real-time positional information for such scheduled service. Based on this data, device 115 can finalize travel time estimates (520) from any candidate parking location to the selected destination. Also, in this example, a user can provide a desired or estimated time to remain at the destination. For example, for a one hour meeting, the user may enter 2 hours, or for dinner 3 hours, and so on. Such information also can be retrieved from a calendaring program (method 500 itself could be initiated from a calendaring program).

Based on the travel time estimates and the desired time at destination, device 115 can narrow the remaining parking opportunities that meet the destination time criteria and are convenient. For example, for a 1 hour meeting, there may be a closer on-street parking location than for a 3 hour meeting, such as where the parking restriction data indicates that only 2 hour parking is available near the destination. Then, remaining parking opportunities can be filtered, sorted, or otherwise limited (521) according to user preferences relating to different parking attributes.

Further information can be obtained in furtherance of such sorting, including information relating to parking costs, as shown in Tables 6 and 7, which respectively show example information that may be contained in databases for street and garage parking, and which also may be accessed through Parking interface 140.

So, for example, a user preference on which parking opportunities may be filtered can include that a user may be willing to walk a certain distance to save a certain amount while parking. Parking profiles also may be created. For example, a general profile may indicate a user would be willing to walk 0.5 miles to save $5.00 in parking. However, an inclement weather profile for the user may prioritize avoidance of walking, even if parking was more expensive. A higher security profile may indicate less walking. A profile itself can be selected based on defined user parameters, as well as information retrieved from databases, such as weather-related information from Destination interface 150, which may access destination weather information stored in destination database 151.

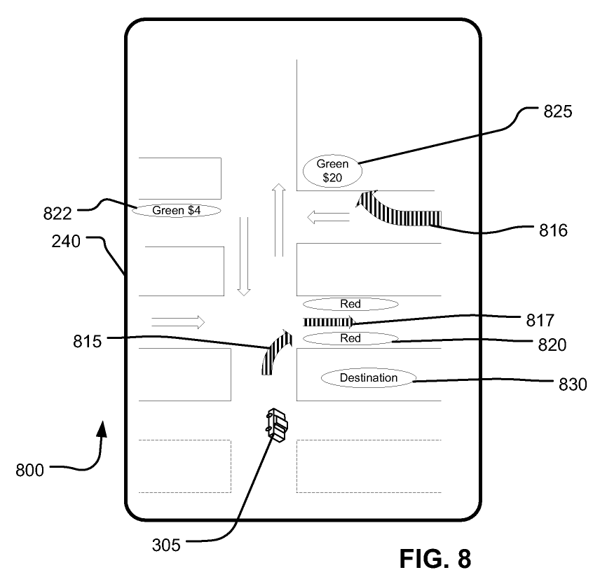

Then, upon such sorting, it is preferred that the user be presented with one or more recommended parking opportunities on a display. An example of such presentation is shown in FIG. 8, with display 800.

Method 500 can loop in this process, waiting for reception of a parking selection (530). Alternatively, method 500 can select one parking destination. In either case, method 500 provides directions to a parking location (example in FIG. 8).

In display 800, a first parking opportunity 822 is indicated in green along with an indication of an estimated parking cost ($4). A second parking opportunity 825 also is illustrated in green with a cost ($20). A present location of a vehicle is shown by icon 305, and arrows 815, 817, and 816, which preferably are of a different color, as indicated by the cross-hatching, indicate a path to a first recommended parking opportunity. It also can be the case that forbidden parking areas are indicated in red, such as red area 820, which helps prevent a user from attempting to park in an area that was calculated to be inappropriate. An ultimate destination 830 of the user also can be identified. Thus, the more prominent, colored arrows guide the user to one or more qualifying parking opportunities. Also, the cost information can allow a user to understand what cost decisions may have been made automatically (here, preference of a $20 parking location over a $4 location). The preference may have been profile-driven as previously discussed, but in a particular circumstance, a user may wish to deviate, and first see if cheaper parking in the other qualifying location (822) is available.

Ultimately, parking by the user is detected (540) and the method 500 can loop waiting for such detection. Then, once parking method 500 can include determining a return-by time (545), updating a present location (550), obtaining updated transit information (555), travel time estimate (560) and updating a return-now time 565. These steps are for tracking a location of the user, and allowing maintenance of a “return-now” time that is calculated to allow sufficient time to return to the parking location prior to an event, such as meter expiration, a garage closing, street sweeping restrictions, and so on. When the “return-now” time is about equal to the current time (decision 570), an alert 575 can be activated, and otherwise method 500 can loop back to 550.

Thus method 500 presents steps of a locational assistance application, where a user can benefit from a device accessing a number of sources of relevant information, coordinating these sources according to established profile or other preference data, and then providing graphical indications of navigation. The method also tracks a user as means of conveyance change, keeping an alert profile set based on the parking restrictions dictated by the location selected for parking.

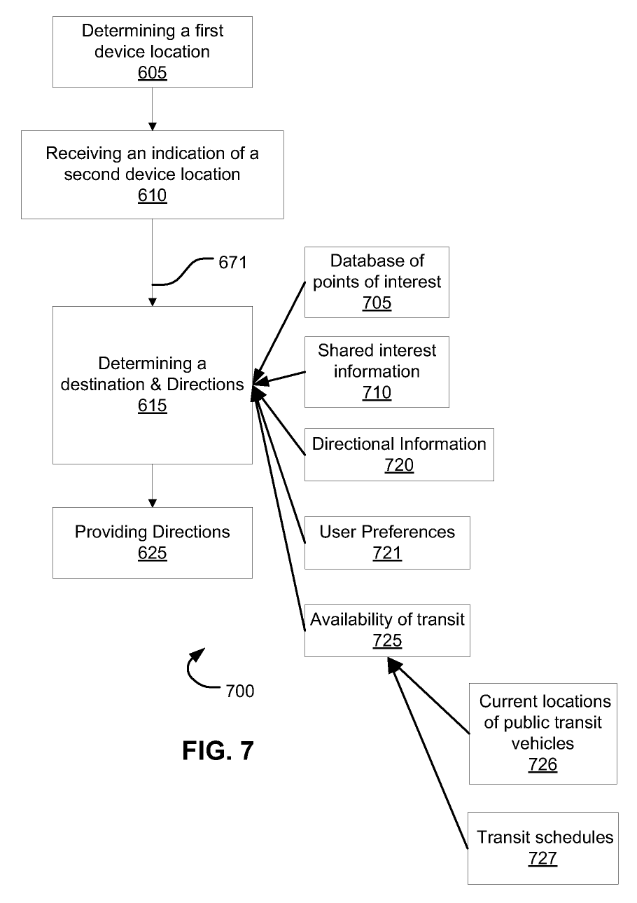

FIG. 7 illustrates aspects of a method 700. Method 700 includes a step of determining a first device location 605 (e.g., device 115 location), and receiving an indication of a second device location 610 (e.g., device 110 location). Such reception can be through a network path such as through base station 125, Internet 130, and base station 120. Then, method 700 includes determining a destination and directions to the destination 615. This determination can involve a number of factors, and other sources of data. First data describing a number of points of interest that are in an area accessible to users of both device 115 and device 110 can be obtained (705) from database 151 through interface 150. Then, shared interest information can be obtained 710. Such information can be obtained, for example, from social networking applications and can be narrowed to an intended category of useful data. For example, dinner or drinks can be indicated by either user. Then, using that shared interest information, and the destination information, a smaller number of candidate destinations can be selected.

Other user preferences 721 also can be used in determining a destination, such as preferences relating to parking costs, amount of walking desired or permitted in arriving at a destination, budgets for certain activities, such as dinner, and so on. Such information can be stored in a profile or profiles for the user.

Availability of certain modes of transit 725 also can be a factor considered in destination selection. Transit related information can include schedules for transit (explained in the context of FIGS. 5-6, above), and also current locations 726 of public transit vehicles that are reporting their locations. It also was described with respect to FIGS. 5-6 how device 115 may retrieve such information from a web service based on provision of route information, and/or location information.

As can be discerned, destination selection can have iterative aspects, wherein availability of certain modes of transit, and even real-time positions of transit vehicles can affect a destination selection. Then, after a destination is selected, the transit and directional information used in selection of a destination also can be used for navigating to the selected destination. For that purpose, directions can be provided 625 to the user from device 115. In a situation of a multi-mode transportation situation, such as where a user first will park than take one or more other means of conveyance, or vice versa, such directions can comprehend each such mode, as explained with respect to FIGS. 5 and 6, above.

Also, since multiple users and devices were involved in the example method 700 of FIG. 7, variations on such methods can include allowing one user at one device to assume priority or control for a given interaction. Other variations can include one device supplying directions for users at both devices. Such supply of directions can be by a text message, for example, where the second device does not have the directional capabilities of the controlling device.

As such, in these examples and other aspects, users can control to what degree transportation factors impact a destination selection. Also, users can allow their devices to provide directional information as well as alert information based on information that the device retrieved by various web services, and processed to produce a result for consumption or review by a user. Thus, a user need not be as engaged in transportation and parking selections, and can instead supply preference information that a device can used in most cases to arrive at a recommendation of one or a few transportation and/or parking choices that meet both known scheduling information as well as more current conditions that may deviate from the schedule.

Methods according to the above-described examples can be implemented using computer-executable instructions that are stored or otherwise available from computer readable media. Such instructions comprise, for example, instructions and data which cause or otherwise configure a general purpose computer, special purpose computer, or special purpose processing device to perform a certain function or group of functions. The computer executable instructions may be, for example, binaries, intermediate format instructions such as assembly language, or source code. Examples of computer-readable media that may be used to store information used or created during methods according to described examples include magnetic or optical disks, flash memory, USB devices provided with non-volatile memory, as well as networks of storage devices such as NAS or SAN equipment.

Such hardware, firmware and software can also be embodied in any of a variety of form factors and devices, including laptops, smart phones, small form factor personal computers, personal digital assistants, and so on. Functionality described herein also can be embodied in peripherals or add-in cards that also can include such features as wireless networking and GPS reception.

Although example distributions of functionality and data were shown and described above, no limitation should be implied as to how such functionality and data can be arranged according to these examples, as one of ordinary skill would be able to use these examples to derive a wide variety of implementations. Although some subject matter may have been described in language specific to examples of structural features and/or method steps, it is to be understood that the subject matter defined in the appended claims is not necessarily limited to these described features or acts. Rather, the described features and steps are disclosed as examples of components of systems and methods within the scope of the appended claims.

1. A method relating to implementing location aware services for mobile device users, comprising:
determining a first location based on a location of a first device by machine processing of one or more of GPS signals and triangulation information;
retrieving parking regulations, through the first device, from a source of such information pertinent to the first location;
algorithmically determining, based on a current time and based on the parking regulations, a timing of an alert to avoid violating the parking regulations pertinent to the first location; and
automatically programming the alert into the first mobile device.

2. The method of claim 1, after programming of the alert, further comprising tracking a current location of the first device, and adjusting a timing of the alert based on an estimated sufficient time to return to the first location without violation of the parking regulations.

3. The method of claim 2, wherein the adjusting accounts for estimated travel times based on current public transit information.

4. The method of claim 3, wherein the current public transit information includes current locations of public transit vehicles on one or more routes leading from the current location to the first location.

5. The method of claim 4, wherein the current locations of the public transit vehicles are obtained through respective GPS devices mounted on the vehicles, through a data network accessed by the mobile device.

6. The method of claim 2, wherein the adjusting accounts for estimated travel times based on a current mode of user transport.

7. The method of claim 1, further comprising calculating a safe radius at a maximum distance from the first location based on one or more of a current mode of user transport and a smoothed average speed of the user.

8. The method of claim 1, further comprising adjusting a timing of the alert based on an smoothed average speed of a user when walking is a current mode of user transport.

9. The method of claim 1, further comprising adjusting a timing of the alert based on an smoothed average speed of a user when walking is a current mode of user transport.

10. A method useful in location-aware mobile devices, comprising:
determining a first device location by machine processing of one or more of GPS signals and triangulation information;
receiving, over a wireless network, at the first device location an indication of a second device location;
determining a destination, based on the first device location, the second device location, a database of points of interest, information concerning shared interests between respective users of the first device ad the second device, and transit options from at least the first device location to the destination; and
determining directions for navigating from the first device location to the destination, the directions including a multi-leg route involving driving an automobile to a parking location, and then using a form of transportation other than the automobile to reach the destination, the directions also based on current public transit information including current locations of public transit vehicles on one or more routes leading from the first device location to the destination.

11. The method of claim 10, wherein the current public transit information includes current locations of public transit vehicles on one or more routes leading from the current location to the first location.

12. The method of claim 11, wherein the current locations of the public transit vehicles are obtained through respective GPS devices mounted on the vehicles, which are aggregated in a resource available through a data network accessed by the first device.

13. A method of location-aware alerts on mobile devices, comprising:
(a) determining a return-to location as a current location of a first device by machine processing of one or more of GPS signals in the first device and triangulation information;
(b) determining a return-by time based on parking regulations retrieved by the first device through a data network from a source of such information pertinent to the return-to location;
(c) iteratively performing steps comprising
(1) re-determining the current location of the first device,
(2) determining an estimated travel time to reach the return-to location from the current location, and
(3) adjusting a return-now time based on the return-by time and the estimate travel time; and
(d) activating the return now alert when a current time is about equal to the return-now time.

14. The method of claim 13, wherein the determining of an estimated travel time to return to the return-to location is based on current location information for public transit vehicles retrieved through the data network from an aggregation point of public transit vehicle location information.

15. The method of claim 13, wherein the determining of an estimated travel time to return to the return-to location is based on a route determined by a direction provider accessible over the data network, the direction provider given input comprising the return-to location, the current location of the mobile device, and the return-by time, and further comprising the direction provider selecting a route constrained by the return-by time and based on current location information for public transit vehicles on potential routes to return the first device to the return-to location.

16. A mobile device for device location based services, comprising:
a wireless interface operable to send and receive information over a wireless network;
a Global Position System (GPS) receiver operable to receive global positioning satellite signals and derive a position for the mobile device from the signals; and
a processor configured to receive the position as an alert position, request delivery of information over the wireless network comprising parking regulations pertinent to the first position, use the parking regulations and other contextual information to formulate an alert definition for avoiding violation of the parking regulations, and update a time for the alert based on then-current positions of the mobile device, wherein each updated time for the alert is based on estimating a time needed to return to the alert position from each then-current position of the mobile device.

17. A method of using current mobile device location and surroundings information, comprising:
receiving an indication of an intended destination of a user, to be reached by means other than an automobile in which the user is presently occupying;
determining a present location of the mobile device by machine processing of one or more of GPS signals and triangulation information;
retrieving parking regulations pertaining to a plurality of distinct parking opportunities, over a data network, from one or more sources of parking information;
forming a first travel time estimate from each of the parking opportunities to the intended destination, and a second travel time estimate from intended destination to each of the parking opportunities;
forming a total time required estimate that includes the first travel time estimate, the second travel time estimate and a time at the intended destination;
providing an indication of which of the parking opportunities allow parking for at least that total amount of time;
receiving a selection of one of the parking opportunities from the user; and
providing directions from the present location of the mobile device to the selected parking opportunity.

18. The method of claim 17, further comprising receiving the time at the intended destination as an input from the user.

19. The method of claim 17, further comprising deriving the time at the intended destination based on information available about the intended destination from networked resources reachable from the data network.

20. The method claim 17, wherein the first and second travel time estimates are based at least in part on current location information for public transit vehicles on possible routes from each of the parking opportunities to the intended destination.
